(19) United States
(12) Patent Application Publication
(10) Pub. No.: US 2015/0274583 A1
(43) Pub. Date: Oct. 1, 2015

(54) GLASS-REINFORCING COMPOSITION AND METHOD OF MANUFACTURING TOUCHSCREEN GLASS USING THE SAME

(71) Applicants: Samsung Display Co., Ltd., Yongin-city (KR); Dongwoo Fine-Chem Co., Ltd., Iksan-si (KR)

(72) Inventors: Soo Min AN, Cheonan-si (KR); Young-Jin Yoon, Jeonju-si (KR); Gi Yong Nam, Anyang-si (KR); Soo Guy Rho, Suwon-si (KR); Sang-Duck Park, Seoul (KR); Kang Bin Yi, Seongnam-si (KR); Jung Bo Lee, Asan-si (KR); Sang Hun Cho, Asan-si (KR); Sang-Tae Kim, Iksan-si (KR); Young-Jun Jin, Iksan-si (KR); Yong Seok Choi, Iksan-si (KR)

(21) Appl. No.: 14/480,019

(22) Filed: Sep. 8, 2014

(30) Foreign Application Priority Data
Mar. 31, 2014 (KR) 10-2014-0037661

(51) Int. Cl. C03C 15/00; C09K 13/08; C03C 21/00

(52) U.S. Cl. CPC C03C 15/00; C03C 21/002; C09K 13/08

(57) ABSTRACT

A glass-reinforcing composition and method of using the same, the composition including 1 weight % to 20 weight % of hydrofluoric acid, 0.1 weight % to 5 weight % of ammonium fluoride, 1 weight % to 20 weight % of an inorganic acid, an organic acid, or 1 weight % to 10 weight % of an organic acid salt, and a remainder of water.

### CROSS-REFERENCE TO RELATED APPLICATION

This application claims priority from and the benefit of Korean Patent Application No. 10-2014-0037661 filed on Mar. 31, 2014, which is hereby incorporated by reference for all purposes as if fully set forth herein.

### BACKGROUND

1. Field

Exemplary embodiments relate to a glass-reinforcing composition and a method of manufacturing touchscreen glass using the same.

2. Discussion of the Background

A touchscreen panel is an input device that allows a person to select an instruction displayed on a screen of an image display device with his or her hand or an object.

To achieve this, the touchscreen panel is disposed on a front face of the image display device to convert a contact position where the person's hand or the object touches into an electric signal. Accordingly, the instruction selected in the contact position is input as an input signal.

Since the touchscreen panel can be replaced with a separate input device that is connected to the image display device, such as a keyboard or a mouse, the popularity of the touchscreen panel has increased.

However, when the touchscreen panel is attached above a panel of the image display device, a volume of the entire display device may be increased. As such, portability may be reduced. Thus, there is a need for the development of a thin touchscreen panel.

However, in the case of a general touchscreen panel, a window is additionally provided on a top surface of the touchscreen panel, in order to improve the strength of the device. As such, the thickness of the touchscreen panel is increased.

Further, the window is generally implemented as a reinforced glass substrate. However, in order to use the reinforced glass substrate as the window, after the glass substrate is cut, a reinforcing process is individually performed on the cut glass substrates.

When an unreinforced glass substrate is used as the window and a touchscreen iii panel is manufactured using mother glass, since a breaking strength of the window is weak, the unreinforced glass substrate may easily crack.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present disclosure provide a glass-reinforcing composition and a method of manufacturing touchscreen glass.

Additional aspects will be set forth in the detailed description which follows, and, in part, will be apparent from the disclosure, or may be learned by practice of the inventive concept.

An exemplary embodiment of the present invention provides a glass-reinforcing composition having 1 weight % to 20 weight % of hydrofluoric acid, 0.1 weight % to 5 weight % of ammonium fluoride, 1 weight % to 20 weight % of an inorganic acid, a, organic acid, or 1 weight % to 10 weight % of an organic acid salt, and a remainder of water.

Another exemplary embodiment of the present invention provides a method of manufacturing touchscreen glass including cutting sheet glass into panel glass in a cell unit; forming a shape of the cut panel glass; and immersing the panel glass whose shape is formed in a glass-reinforcing composition. The glass-reinforcing composition has 1 weight % to 20 weight % of hydrofluoric acid, 0.1 weight % to 5 weight % of ammonium fluoride, 1 weight % to 20 weight % of inorganic acid, organic acid or 1 weight % to 10 weight % of organic acid salts, and a remainder of water.

According to an exemplary embodiment of the present invention, since the glass-reinforcing composition has a predetermined amount of hydrofluoric acid, ammonium fluoride, an inorganic acid, and an organic acid, when the glass is immersed, it is possible to form depressions having an appropriate size, and it is possible to allow the glass to have an appropriate elongation percentage.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIGS. 1A and 1B illustrate a crack before and after a blunting process has been performed a glass-reinforcing composition.

FIG. 2 is a schematic diagram illustrating a touchscreen glass for a mobile phone.

FIG. 3 is a SEM image of cut glass after being immersed in the glass-reinforcing composition.

FIG. 4 is a block diagram illustrating a method of manufacturing a touchscreen glass, according to an exemplary embodiment of the present disclosure.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

A touchscreen glass-reinforcing composition according to an exemplary embodiment of the present invention will be now described in detail.

When touch screen glass is manufactured, sheet glass is cut into panel glass, and the panel glass is shaped to be suitable for a particular application. In this case, micro-cracks (cracks hereinafter) are formed cut surfaces of the glass due to the cutting. Thus, an elongation percentage of the glass is decreased, and the glass may be easily broken by even a small impact.

Accordingly, a separate process for reinforcing the cut glass may be performed. Since the cracks on the cut surfaces of the glass are etched through the reinforcing process, the reinforcing process may also be referred to as a healing process.

The present disclosure relates to a glass-reinforcing composition used in the healing process, and a method of manufacturing touchscreen glass using the same. When the shaped glass is processed using the glass-reinforcing composition, the cracks on the cut surface are etched to form depressions, so that intensity of stress is not localized in the micro cracks.

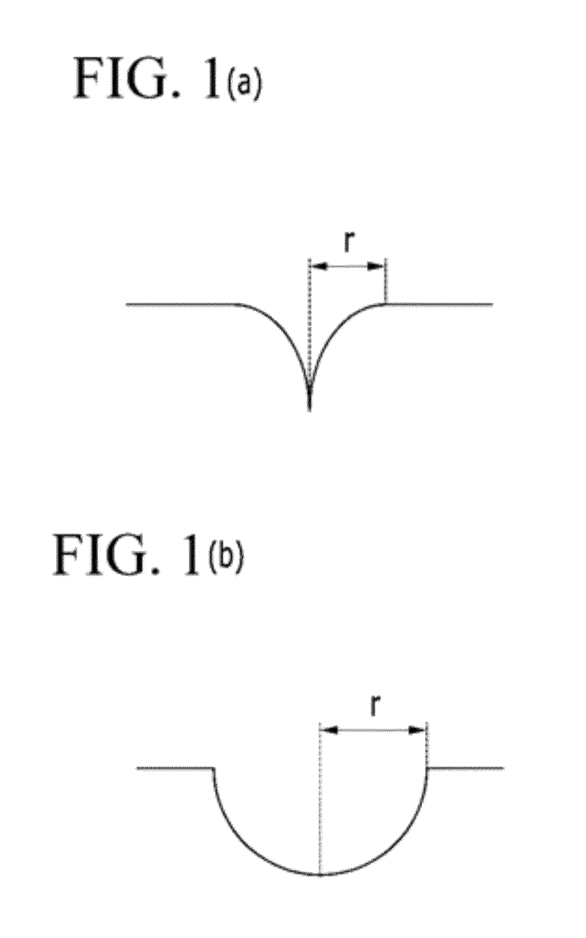

FIG. 1A illustrate a crack formed in glass by cutting. FIG. 1B illustrates a depression formed by etching the crack using the glass-reinforcing composition.

Referring to FIG. 1A, the crack is pointed in cross-section. A relation between a crack width r and a stress a applied to the glass can be expressed as the following equation.

α=1+2L/r

Accordingly, as the radius r is decreased, and the stress a is increased.

However, referring to FIG. 1B, the healing process increases the radius r of the crack. In particular, the crack is etched by the healing process, and, thus, the depression having a semicircular cross-section is formed. In other words, the crack is blunted by the etching.

Accordingly, the stress a applied to the glass is decreased. The decrease in the stress leads to an increase in the elongation percentage of the glass. That is, in the healing process, isotropic etching is performed on the glass around the crack to form a gentle semicircular cross-section, so that the stress applied to the glass is reduced and the elongation percentage of the glass is increased. Accordingly, the glass is reinforced by the healing process.

The glass-reinforcing composition according to the exemplary embodiments of the present disclosure may include 1 weight % to 20 weight % of hydrofluoric acid, 0.1 weight % to 5 weight % of ammonium fluoride, 1 weight % to 20 weight % of an inorganic acid, 1 weight % to 20 weight % of an organic acid, and a remainder of water. The glass-reinforcing composition may optionally include 1 weight % to 10 weight % of an organic acid salt.

In the glass-reinforcing composition, the hydrofluoric acid serves to etch the glass. That is, the hydrofluoric acid is dissociated into H+ cations and F− anions in deionized water, and it dissociates the glass on contact. Accordingly, the glass is etched.

When the content of the hydrofluoric acid is less than 1 weight %, the glass is not sufficiently etched. Accordingly, the elongation percentage of the glass is not increased.

Meanwhile, when the content of the hydrofluoric acid is greater than 20 weight %, an etching rate of the glass is excessively high, and the etching is difficult to control. That is, the cracks may be excessively etched and other portions of the glass may be damaged.

In the glass-reinforcing composition, the ammonium fluoride can control a degree of etching to control the shape of the etched cracks. That is, ammonium ions in the ammonium fluoride adhere to a glass surface to control pH. The ammonium fluoride serves as a buffer that controls rapid etching of the glass.

When the ammonium fluoride is less than 0.1 weight %, it is difficult to control the degree of etching of the glass. Meanwhile, when the ammonium fluoride is more than 5 weight %, the etching rate of the glass is remarkably decreased. Thus, etching time is excessively increased.

In the glass-reinforcing composition, the inorganic acid controls the pH to appropriately increase the etching rate. That is, when the pH is decreased, the etching speed is increased, and when the pH is increased, the etching rate is reduced.

When the inorganic acid is less than 1 weight %, the pH is not sufficiently controlled, and, thus, the etching rate may be remarkably decreased. When the content of the inorganic acid is more than 20 weight %, the etching rate is excessively high and the glass may etched at locations other than the cracks.

The inorganic acid may be one or more selected from sulfuric acid (H₂SO₄), hydrochloric acid (HCl), nitric acid (HNO₃), phosphoric acid (H₃PO₄), sulfamic acid (SO₃HNH₂), perchloric acid (HClO₄), chromic acid (HCrO₄), sulfurous acid (H₂SO₃), and nitrous acid.

In the glass-reinforcing composition, the organic acid increases isotropy and increases the degree of etching of the glass to improve the processing amount. That is, the organic acid allows the cracks to be etched into a uniform semicircular cross-section through the isotropic etching. Further, the organic acid increases the degree of etching of the glass, so that more glass can be processed in the same time. Furthermore, when the organic acid is added to the glass-reinforcing composition, the solution has the same performance even after the solution is preserved for a long time.

When the content of the organic acid is less than 1 weight %, an effect of increasing the etching isotropy and etching rate may not be sufficiently exhibited. Moreover, when the content of the organic acid is more than 20 weight %, the etching rate of the glass is excessively high, and the glass may be etched in areas other than the cracks, so that the damage may be caused.

The organic acid may be one or more selected from a carboxylic acid, a dicarboxylic acid, a tricarboxylic acid, and/or a tetracarboxylic acid. For example, the organic acid may be one or more selected from acetic acid, butanoic acid, citric acid, formic acid, gluconic acid, glycolic acid, malonic acid, oxalic acid, pentanoic acid, sulfobenzoic acid, sulfosuccinic acid, sulfophthalic acid, salicylic acid, sulfosalicylic acid, benzoic acid, lactic acid, glyceric acid, succinic acid, malic acid, tartaric acid, isocitric acid, propenoic acid, imminodiacetic acid, and ethylenediaminetetraacetic acid (EDTA).

In the touchscreen glass-reinforcing composition, the water may be deionized water. In this case, resistivity of the deionized water may be equal to or more than 18 M)/cm. The content of the water may be appropriately controlled to allow the total weight of the entire composition to become 100%. The water may have semiconductor process purity.

Further, the glass-reinforcing composition may additionally include surfactants, thickening agents, and/or the like. The surfactants may be anionic surfactants or nonionic surfactants. The thickening agents are substances that are added to increase the viscosity of the solution and give thixotropy to the solution. Any suitable thickening agents may be used.

A method of manufacturing touchscreen glass, according to exemplary embodiments of the present invention, will be described below. The method of manufacturing touchscreen glass according to the exemplary embodiment of the present invention includes cutting sheet glass into panel glass in a cell unit, forming a shape of the cut panel glass, and immersing the panel glass whose shape is formed in a glass-reinforcing composition having 1 weight % to 20 weight % of hydrofluoric acid, 0.1 weight % to 5 weight % of ammonium fluoride, 1 weight % to 20 weight % of an inorganic acid, 1 weight % to 20 weight % of an organic acid, and a remainder of water. The composition may also include 1 weight % to 10 weight % of an organic acid salt.

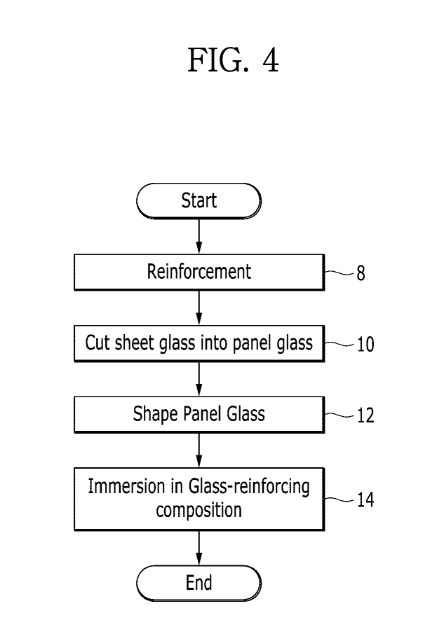

FIG. 4 illustrates the method of manufacturing touchscreen glass, according to an exemplary embodiment of the present disclosure.

In operation 10, sheet glass is cut into the panel glass appropriate for one device. The sheet glass may be cut using physical or chemical methods such as a wheel, laser, water-jet, etching, or the like.

According to some embodiments, the method may include operation 8, which may be optionally performed before the sheet glass is cut into the panel glass. Operation 8 may include reinforcing the sheet glass through ion exchange.

Operation 8 may be performed by immersing the sheet glass in a KNO₃ solution and heating the immersed sheet glass at a temperature of 400 to 450 degrees, for about 15 to 18 hours, and strength of a surface of a glass substrate is improved by substituting sodium (Na) components on the surface of the glass substrate with potassium (K) components. That is, after the operation 8 is performed, a reinforcing layer, in which ions are substituted, is formed on the surface of the sheet glass. However, other suitable reinforcing processes may be used.

In operation 12 the panel glass is shaped. The shaping may be performed by a CNC (Computerized Numerical Control) process, or the like.

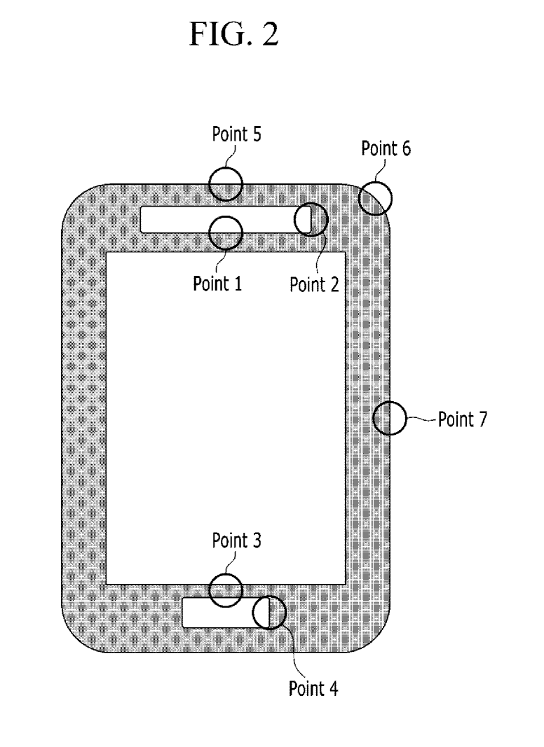

FIG. 2 is a schematic diagram illustrating panel glass shaped into touchscreen glass for a mobile phone. Referring to FIG. 2, holes for a speaker and a home button are formed. Furthermore, an edge of the glass is processed, so as to be a smooth curved line.

As indicated by a circle of FIG. 2, the cracks illustrated in FIG. 1A are caused on the cut surfaces during the shaping operation 12. The cracks lead to deterioration in the strength of the glass.

The reinforcement layer formed by the reinforcement operation 8 is formed on front and/or rear surfaces of the glass substrate. Accordingly, cut surfaces of the panel glass are not protected by the reinforcement layer and are weaker than the protected surfaces.

Referring again to FIG. 4, in operation 14, the shaped panel glass is immersed in the glass-reinforcing composition described above. That is, the glass-reinforcing composition may have 1 weight % to 20 weight % of hydrofluoric acid, 0.1 weight % to 5 weight % of ammonium fluoride, 1 weight % to 20 weight % of an inorganic acid, 1 weight % to 20 weight % of an organic acid, and a remainder of water. The panel glass may be immersed at a temperature of 25° C. for 3 minutes, for example.

Operation 14 may further include applying a protective layer to front and/or rear surfaces of the panel glass, before immersing the panel glass in the glass-reinforcing composition. The protective layer serves to protect the covered surfaces of the glass from contact with the glass-reinforcing composition. The protective layer can be attached or detached, and may be formed in the form of a film or a paste. That is, the protective layer may be attached before the immersion, and may be removed after the immersion is complete.

The cracks illustrated in FIG. 1A are etched by the glass-reinforcing composition, resulting in the structure shown in FIG. 1B. As described above, the etching reduces the stress applied to the glass to increase the elongation percentage of the glass. That is, brittleness of the glass is reduced and the elongation percentage thereof is increased, so that the glass is not easily broken by the external impact.

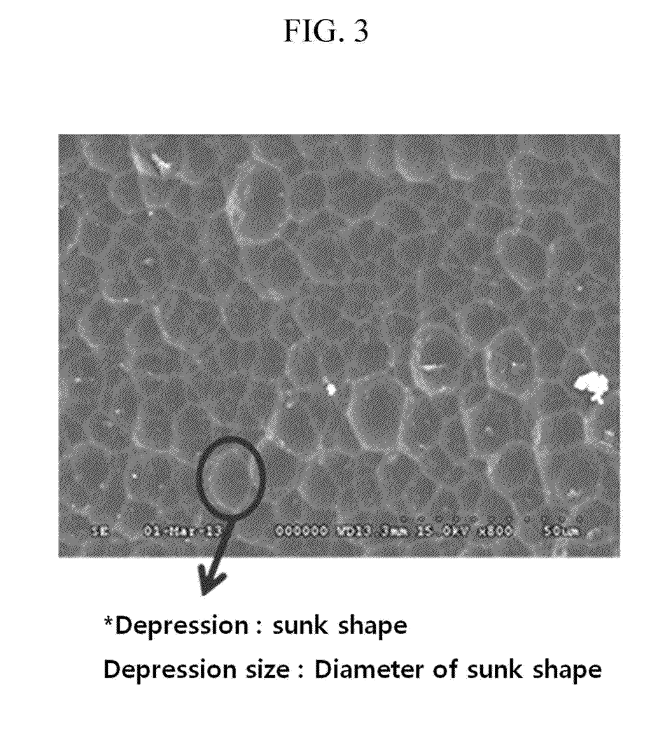

FIG. 3 is an SEM image of the glass after being immersed in the glass-reinforcing composition. Referring to FIG. 3, it can be seen that the cracks have been etched into circular depressions.

The depressions may have diameters of 6 um to 12 um. When the glass includes the depressions having such a size, an elongation percentage of the glass is equal to or more than 0.6.

Next, effects of the glass-reinforcing composition and the method of manufacturing touchscreen glass according to the exemplary embodiments of the present invention will be described through the following experiments.

Sheets of glass were immersed in glass-reinforcing compositions of Experimental Embodiments 1-3 and Comparative Example 1, having the compositions shown in Table 1. Sizes of depressions formed and elongation percentages of the sheets of glass are also represented in Table 1.

TABLE 1

| | | | | | Depression | Elongation |
|---|---|---|---|---|---|---|
| | | | Nitric | Acetic | diameter | percentage |
| | HF | AF | acid | acid | (um) | (%) |
| Experimental | 7 | 1 | 7 | 1 | 9.55 | 1.14 |
| Embodiment 1 | | | | | | |
| Experimental | 7 | 1 | 7 | 1 | 9.52 | 1.12 |
| Embodiment 2 | | | | | | |
| Experimental | 7 | 1 | 7 | 3 | 9.55 | 1.15 |
| Embodiment 3 | | | | | | |
| Comparative | 7 | 1 | 7 | — | 9.51 | 1.12 |
| Example 1 | | | | | | |

In this case, in the present experiments, glass substrates of 10 kg are manufactured, and after the glass substrates are immersed at a constant temperature of 25° C. for 3 minutes, the glass substrates are cleaned, and the diameters of the depressions and the elongation percentage of the glass are measured.

As represented in Table 1, it can be seen that when the sheets of glass are immersed in the glass-reinforcing compositions, depressions having diameters of 6 um to 12 um were formed, and the elongation percentages were at least 0.6.

Further, in order to compare processing speeds by addition of the organic acid, after glass-reinforcing compositions having the same composites represented in Table 2 are produced, the amounts of etched glass and preserved periods for which solutions are preserved without losing etching performance are measured and represented in Table 2.

TABLE 2

| | | | | | Amount of | Preserved |
|---|---|---|---|---|---|---|
| | | | Nitric | Acetic | etched glass | period |
| | HF | AF | acid | acid | (ppm) | (day) |
| Experimental | 7 | 1 | 7 | 5 | 1000 | 7 |
| Embodiment 4 | | | | | | |
| Comparative | 7 | 1 | 7 | — | 200 | 1 |
| Example 1 | | | | | | |

The present experiments are performed under the same conditions as those of the previous experiments, and the amounts of etched glass after the experiments are measured. As a result, it can be seen in Experimental Embodiment 4, in which acetic acid (organic acid) is added, that the amount of etched glass is 1000 ppm, which demonstrates a large amount of etching and a high etch rate. However, it can be seen in Comparative Example 1 in which acetic acid (organic acid) is not added that since the amount of etched glass is 200 ppm, an etching rate is about a fifth of that of Experimental Embodiment 4 where the acetic acid is added.

That is, it can be seen that when the acetic acid is added, the processing speed is five time faster under the same conditions.

Further, when the acetic acid is not added, the healing performance of the solution is lost after one day. However, when the acetic acid is added, the healing performance thereof can be maintained for one week.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A glass-reinforcing composition comprising:
1 weight % to 20 weight % of hydrofluoric acid;
0.1 weight % to 5 weight % of ammonium fluoride;
1 weight % to 20 weight % of an inorganic acid;
1 weight % to 20 weight % of an organic acid; and
a remainder of water.

2. The glass-reinforcing composition of claim 1, wherein the inorganic acid is one or more selected from a group consisting of sulfuric acid (H₂SO₄), hydrochloric acid (HCl), nitric acid (HNO₃), phosphoric acid (H₃PO₄), sulfamic acid (SO₃HNH₂), perchloric acid (HClO₄), chromic acid (HCrO₄), sulfurous acid (H₂SO₃), and nitrous acid.

3. The glass-reinforcing composition of claim 1, wherein the organic acid is one or more selected from a group consisting of a carboxylic acid, a dicarboxylic acid, a tricarboxylic acid, and a tetracarboxylic acid.

4. The glass-reinforcing composition of claim 1, wherein the organic acid is one or more selected from a group consisting of acetic acid, butanoic acid, citric acid, formic acid, gluconic acid, glycolic acid, malonic acid, oxalic acid, pentanoic acid, sulfobenzoic acid, sulfosuccinic acid, sulfophthalic acid, salicylic acid, sulfosalicylic acid, benzoic acid, lactic acid, glyceric acid, succinic acid, malic acid, tartaric acid, isocitric acid, propenoic acid, imminodiacetic acid, and ethylenediaminetetraacetic acid (EDTA).

5. The glass-reinforcing composition of claim 1, wherein the water is deionized water.

6. The glass-reinforcing composition of claim 5, wherein the deionized water has a resistivity of at least 8 MΩ/cm.

7. The glass-reinforcing composition of claim 1, wherein the glass-reinforcing composition further comprises a surfactant, a viscosity increasing agent, or a combination thereof.

8. A method of manufacturing touchscreen glass, comprising:
cutting sheet glass into panel glass;
shaping the cut panel glass; and
immersing the shaped panel glass in a glass-reinforcing composition,
wherein the glass-reinforcing composition comprises:
1 weight % to 20 weight % of hydrofluoric acid;
0.1 weight % to 5 weight % of ammonium fluoride;
1 weight % to 20 weight % of an inorganic acid,
1 weight % to 20 weight % of an organic acid; and
a remainder of water.

9. The method of claim 8, further comprising reinforcing the sheet glass through an ion exchange process, before the cutting of the sheet glass into the panel glass.

10. The method of claim 8, wherein the cutting of the sheet glass into the panel glass comprises using a wheel, a laser, a water-jet, or an etchant.

11. The method of claim 8, wherein the shaping of the cut panel glass comprises using a CNC (Computerized Numerical Control) process.

12. The method of claim 8, further comprising forming a protective layer on the shaped panel glass, before the immersing of the shaped panel glass.

13. The method of claim 12, wherein the protective layer comprises a detachable film or paste.

14. The method of claim 8, wherein after the immersing of the shaped panel glass comprises etching cracks into circular depressions.

15. The method of claim 14, wherein diameters of the depressions range from 6 um to 12 um.

16. The method of claim 14, wherein an elongation percentage of the glass after being immersed in the glass-reinforcing composition is at least 0.6.

17. The method of claim 8, wherein the inorganic acid is one or more selected from a group consisting of sulfuric acid (H₂SO₄), hydrochloric acid (HCl), nitric acid (HNO₃), phosphoric acid (H₃PO₄), sulfamic acid (SO₃HNH₂), perchloric acid (HClO₄), chromic acid (HCrO₄), sulfurous acid (H₂SO₃), and nitrous acid.

18. The method of claim 8, wherein the organic acid is one or more selected from a group consisting of a carboxylic acid, a dicarboxylic acid, a tricarboxylic acid, and a tetracarboxylic acid.

19. The method of claim 8, wherein the organic acid is one or more selected from a group consisting of acetic acid, butanoic acid, citric acid, formic acid, gluconic acid, glycolic acid, malonic acid, oxalic acid, pentanoic acid, sulfobenzoic acid, sulfosuccinic acid, sulfophthalic acid, salicylic acid, sulfosalicylic acid, benzoic acid, lactic acid, glyceric acid, succinic acid, malic acid, tartaric acid, isocitric acid, propenoic acid, imminodiacetic acid, and ethylenediaminetetraacetic acid (EDTA).

20. The method of claim 8, wherein the water comprises deionized water having a resistivity of at least 18 MΩ/cm.
